(19) United States
(12) Patent Application Publication
(10) Pub. No.: US 2013/0341442 A1
(43) Pub. Date: Dec. 26, 2013

(54) DEVICE FOR DISAGGREGATING FIELD ADDITIVES

(71) Applicants: Keith Putman, Assiniboia (CA); Kelly Johnson, Assiniboia (CA); Jason Johnson, Assiniboia (CA)

(72) Inventors: Keith Putman, Assiniboia (CA); Kelly Johnson, Assiniboia (CA); Jason Johnson, Assiniboia (CA)

(21) Appl. No.: 13/918,345

(22) Filed: Jun. 14, 2013

(30) Foreign Application Priority Data
Jun. 18, 2012 (CA) 2780498

(51) Int. Cl. B02C 19/00

(52) U.S. Cl. CPC B02C 19/0056
USPC 241/37.5; 241/277; 241/236

(57) ABSTRACT

A device for disaggregating crop field additives that have been aggregated due to conditions such as compression or moisture. The device comprises a series of spined rollers in parallel orientation extending across an open passage, the rollers rotated by a motor such that the spines can break apart the aggregates falling through the open passage before application of the additives.

### FIELD OF THE INVENTION

The present invention relates to agricultural implements, and more particularly to implements for handling field additives such as fertilizer.

### BACKGROUND OF THE INVENTION

It is well known in the agricultural arts to employ various field additives to address particular field conditions. For example, fertilizer may be a desirable field input to ensure a healthy crop. Such additives may come in liquid or granular form, and implements have been developed to allow the introduction of such additives to the field.

Fertilizers of various types are seen as a crucial type of field additive, and a popular form of fertilizer is the granular variety. Granular fertilizers are easy to transport, handle and apply, and are often the form of choice for those working in the agricultural sector.

However, it is known that granular fertilizers are sometimes susceptible to clumping or aggregation, which can occur due to storage conditions such as compression and moisture. White this does not always present a problem for the user, certain implements can be rendered inoperative if fertilizer is allowed to aggregate and remain in that state. For example, a seeder air tank can be used for applying granular fertilizer, but aggregated product can plug the air lines.

Several solutions have been proposed to address this problem. For example, screening is often used as a way to keep the aggregated fertilizer out of the downstream process, but this is a time-consuming approach that results in waste of the aggregated additive.

What is needed, therefore, is a means for disaggregating clumps of field additives so that they can be used rather than wasted.

### SUMMARY OF THE INVENTION

The present invention accordingly seeks to provide a simple device capable of breaking up aggregations of such field additives to avoid plugging of the delivery systems.

According to a broad aspect of the present invention there is provided a device for disaggregating field additives, the device comprising:
a peripheral wall defining an open space therein for receiving the field additives;
at least one roller within the open space and mounted on the peripheral wall for rotational movement;
at least one protuberance on the at least one roller and extending generally outwardly therefrom; and
means for imparting rotation to the at least one roller and thereby causing the at least one protuberance to pass through the open space adjacent the at least one roller;
   such that the at least one protuberance contacts at least a portion of the field additives as they pass through the open space.

Devices according to the present invention preferably comprise a plurality of rollers, each comprising a plurality of protuberances, where the plurality of rollers are in parallel alignment within the open space. To better ensure disaggregation of clumps, the protuberances of adjacent rollers are preferably off-set so as to alternatingly mesh and unmesh during rotation of the adjacent rollers, and the plurality of protuberances may be provided in spaced-apart orientation across an outer surface of each of the plurality of rollers. The protuberances of the adjacent rollers are preferably positioned and configured such that disaggregated field additives can progress downwardly past the adjacent rollers during rotation of the adjacent rollers.

In further exemplary embodiments of the present invention, each roller comprises a driven end, which driven end passes through the peripheral wall and terminates in a contact surface, and the means for imparting rotation comprise a motor (preferably a hydraulic motor powered by hydraulic lines) situated on an outer surface of the peripheral wall and a connection member for connecting the motor and the contact surface such that when the motor is actuated it causes the connection member to impart rotational movement to the contact surface of the roller. The contact surface is preferably a toothed surface (for example, a gear) and the connection member is preferably a chain drive belt that can mate with that toothed surface. Where there is a plurality of rollers, each would have a driven end and a toothed surface, and the chain drive belt would mate with each toothed surface in series.

In yet further exemplary embodiments of the present invention, the device further comprises an upper wall for channeling the field additives toward the protuberances. A safety grill is preferably positioned overlying the rollers. The device preferably comprises mounting means for mounting the peripheral wall on a receiving implement, although the nature and configuration of the mounting means will depend on the type of receiving implement, as would be obvious to one skilled in the art. The receiving implement may be a grain auger, a belt conveyor, a transfer auger, or one of many other implements used to transfer field additives. Also, the open space extends through the device to allow the field additives to pass through the device to the receiving implement or other holding or transport means.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention:

FIG. 1 is a top plan view of a device according to the present invention, without the upper wall and safety grill;

FIG. 2 is a detailed perspective view of a spined member and a corresponding square shaft;

FIG. 3a is one embodiment of a roller/protuberance configuration;

FIG. 3b is an alternative embodiment of roller/protuberance configuration;

FIG. 4 is a top plan view of a device according to the present invention showing the positioning of the upper wall and safety grill;

FIG. 5a is a simplified front elevation view of the device, showing the arrangement of the chain belt drive system;

FIG. 5b is a simplified rear elevation the device; and

FIG. 6 is a simplified side elevation view of a device mounted on an auger boot.

A preferred embodiment of the present invention will now be described with reference to the accompanying drawings.

### DETAILED DESCRIPTION OF EXEMPLARY EMBODIMENTS

Referring now to the accompanying drawings, an embodiment of a device 10 according to the present invention is illustrated.

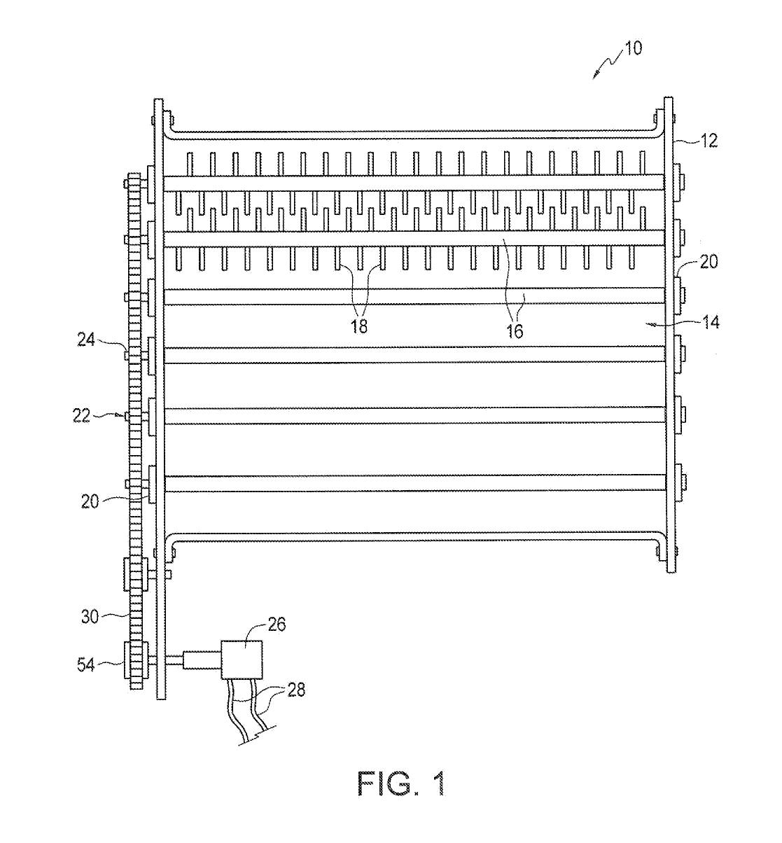

Referring now in detail to FIG. 1, the basic configuration of the device 10 is illustrated. The device 10 comprises a peripheral wall 12, which in the illustrated embodiment is four metal walls connected by means of bolts, the walls composed of 5/16 inch iron or stainless steel. The peripheral wall 12 defines an open space 14 therein, through which field additives are intended to pass on the way to further handling steps beyond the scope of the invention.

A plurality of rollers 16 are positioned within the open space 14 and are rotatably mounted on the peripheral wall 12. There are preferably six or seven rollers 16, although the most desirable number will depend on the site of the device 10 and the open space 14. The rollers 16 extend across the open space 14, with one end passing through the peripheral wall and being rotatably secured using collars 20, and the other driven end 22 passing through the opposite side of the peripheral wall 12 for connection to means for imparting rotation, which is described in detail below.

Each of the rollers 16 is provided with a plurality of metal protuberances or spines 18; this is shown on only two adjacent rollers 16 in FIG. 1 for simplicity of illustration, although all six rollers 16 would be provided with spines 18 in a working embodiment. These spines 18 are the elements intended to strike the downwardly passing field additives and help to break up any aggregates. The positioning and orientation of the spines 18 could be accomplished in any number of ways, but the illustrated embodiment of FIG. 1 shows spines 18 on adjacent rollers 16 being arranged so that they mesh and unmesh during rotation of the rollers 16. While it is desirable to enable meshing of spines 18, the arrangement must still allow for unaggregated field additives to move past the rollers 16 through the open space 14.

The device 10 also comprises means for imparting rotation to the rollers 16 so that the spines 18 can strike the incoming field additive stream and break up aggregates. In the embodiment shown in FIG. 1, this is accomplished by a combination of a hydraulic motor 26 and a chain drive belt 30. The hydraulic motor 26 is of conventional form and function, fed by hydraulic lines 28 which can tie into existing on-site equipment for ease of implementation. As can be seen in FIGS. 1, 5a and 5b, the driven ends 22 of the rollers 16 pass through the peripheral wall 12 so that they can engage the chain drive belt 30, whereas the opposite ends of the rollers 16 pass through the opposite side of the peripheral wall 12 and are held in place by collars 20. The motor 26 rotates a driven gear 54, which gear 54 in turn cause the chain belt 30 to move against the driven ends 22 of the rollers 16. The driven ends 22 are provided with a contact surface 24 that is configured to mate with the chain belt 30; preferably, this contact surface 24 is toothed such as a gear profile. The chain belt 30 contacts each of the contact surfaces 24 in series, as can be seen in simplified form in FIG. 5a. As the chain belt 30 is driven by the driven gear 54, it causes the rollers 16 to rotate through contact with the contact surfaces 24. As the rollers 16 rotate, the spines 8 accordingly pass through the open space 14 adjacent the roller 16.

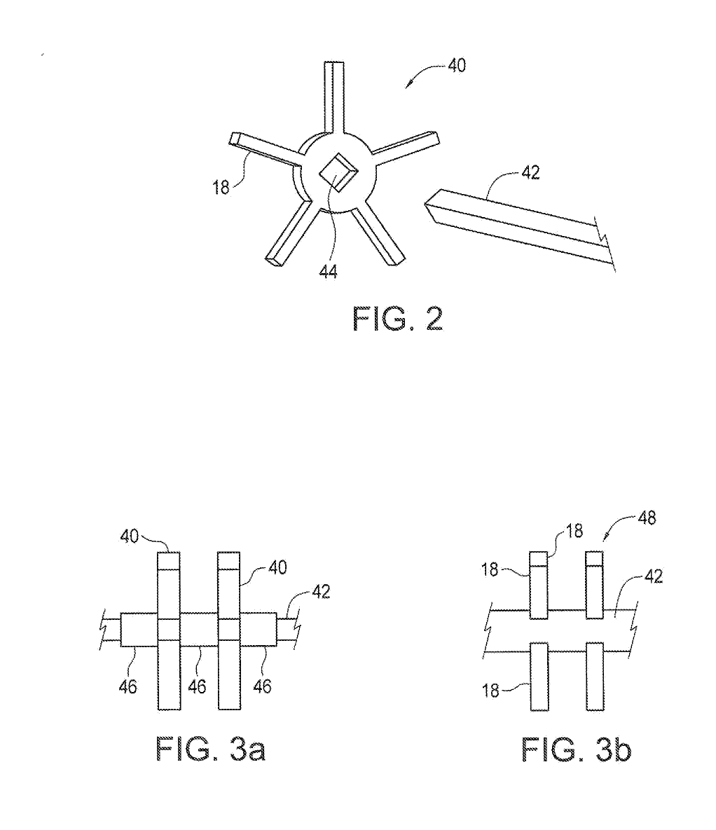

Turning now to FIGS. 2, 3a and 3b, variant embodiments of the spines 18 are illustrated. FIG. 2 illustrates a spined member 40 with five spines 18, although it will be obvious to one skilled in the art that other numbers of spines could also be employed, for example four or six. The spined member 40 is provided with a square opening 44 that is configured to receive a square shaft 42, such that rotation of the square shaft 42 will cause the spined member 40 to rotate. FIG. 3a illustrates how such a spined member 40 could be used to produce a roller 16 according to the present invention. In FIG. 3a, the square shaft 42 receives alternating spined members 40 and spacers 46, which spacers 46 can be used to ensure a proper spacing between adjacent spines 18 so that the spines 18 of adjacent rollers 16 can mesh and unmesh as desired. FIG. 3b illustrates a variant embodiment with a welded spine arrangement 48, where the spines 18 are welded directly onto the shaft 42. Although spines 18 have been illustrated as being located in aligned radial orientation around the shaft 42, it will be obvious to one skilled in the art that spines 18 could be distributed in less uniform patterns across the surface of the shaft 42, so long as spines 18 of adjacent rollers 16 would not impact each other and inhibit the necessary rotation of the rollers 16.

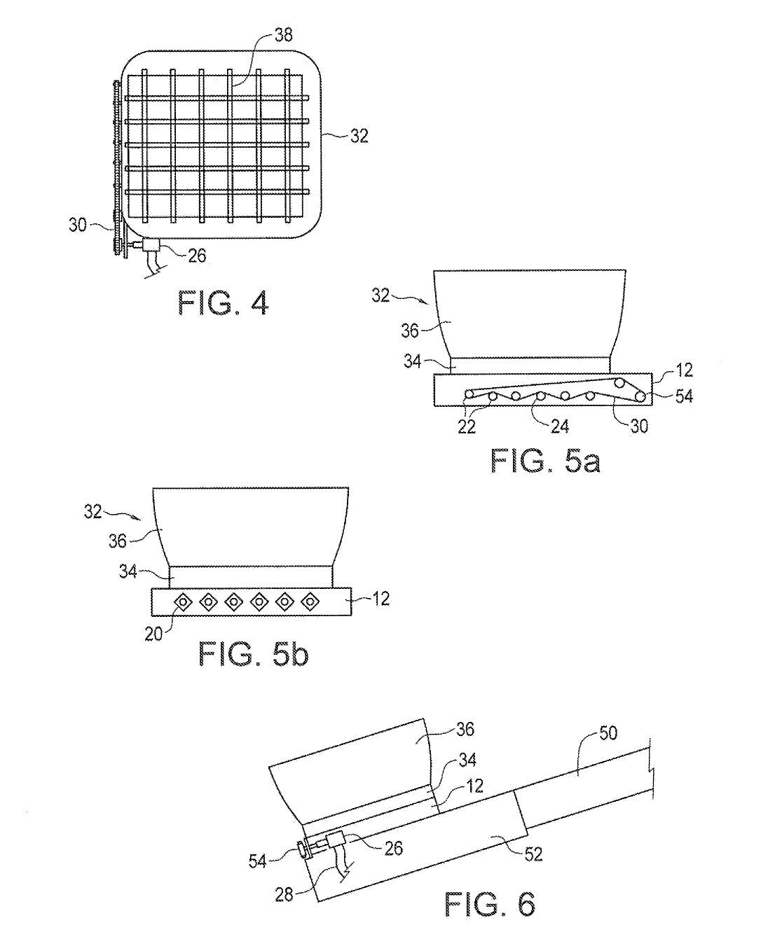

The device 10 preferably comprises an upper wall 32, as can be seen in FIGS. 4, 5a, 5b and 6. The upper wall 32 serves the two-part function of helping channel field additives toward the rollers 16 and also helping prevent field additive toss to the sides of the device 10. As can be seen in FIGS. 5a and 5b, the upper wall 32 comprises a lower portion 34 and an upper portion 36. The lower portion 34 is composed of metal, preferably iron or stainless steel, and it is mounted on the top of the peripheral wall 12 and serves as the mounting base for the upper portion 36. The upper portion 36 is preferably composed of two-ply belting and is bolted to the lower portion 34.

FIG. 4 illustrates the arrangement and positioning of a safety grill 38. The safety grill 38 is composed of steel and is welded in place against the inner walls of the lower portion 34. The safety grill 38 serves to protect a user by providing a barrier between the user and the rapidly rotating rollers 16 with spines 18.

As indicated above, devices according to the present invention may incorporate mounting means for mounting such devices on desired implements or other equipment. Given this, it will be obvious that mounting means will vary significantly depending on the particular implement. For example, different mounting means might be required to mount a device to a grain auger as opposed to a belt conveyor. In each case, however, one skilled in the art would be able to easily determine appropriate means for securing the device in position. For example, FIG. 6 illustrates a device 10 being used with a boot 52 of an auger 50. The device 10 is shown nested inside the upper opening of the boot 52, such that mechanical fastening may not be required. In other cases not shown, mechanical fastening may be necessary to ensure safety and utility when the present invention is used with particular equipment or machinery.

In operation, then, a user would position a device 10 beneath a source of a field additive such as granular fertilizer and above a desired storage or transport object. For example, the device 10 might be situated under the outlet of a fertilizer storage container, with the intake end of a transport auger positioned under the device 10 to receive and transport the disaggregated fertilizer. With the device 10 in position, the user would then attach the hydraulic lines 28 (if not already connected) and direct power to the motor 26. The motor 26 would cause rotation of the driven gear 54, causing the chain drive belt 30 to impart rotational force to the driven ends 22 of the rollers 16. With the rollers 16 rotating and the spines 18 moving through the open space 14 adjacent the rollers 16, the user can then allow the downward flow of fertilizer into the device 10. Unaggregated fertilizer will generally pass through the device 10 with minimal impedance. If the fertilizer contains any aggregated clumps, those aggregates would be contacted by the spines 18 and broken up, allowing the now-smaller pieces to pass between the rollers 16 and downwardly toward the desired storage or transport object.

As can be readily seen, then, the device of the present invention presents significant advantages over the prior art. It can provide for higher throughout and reduced waste when compared with sieving or screening of the fertilizer. Also, the device can be used for unloading rail cars or semi-trailers, long before additives get to application site. Other advantages would be obvious to those skilled in the art.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

1. A device for disaggregating field additives, the device comprising:
a peripheral wall defining an open space therein for receiving the field additives;
at least one roller within the open space and mounted on the peripheral wall for rotational movement;
at least one protuberance on the at least one roller and extending generally outwardly therefrom; and
means for imparting rotation to the at least one roller and thereby causing the at least one protuberance to pass through the open space adjacent the at least one roller;
such that the at least one protuberance contacts at least a portion of the field additives as they pass through the open space.

2. The device of claim 1 wherein the device comprises a plurality of rollers each comprising a plurality of protuberances, the plurality of rollers in parallel alignment within the open space.

3. The device of claim 2 wherein the protuberances of adjacent rollers are off-set so as to alternatingly mesh and unmesh during rotation of the adjacent rollers.

4. The device of claim 2 wherein the plurality of protuberances are provided in spaced-apart orientation across an outer surface of each of the plurality of rollers.

5. The device of claim 1 wherein:
the at least one roller comprises a driven end, which driven end passes through the peripheral wall and terminates in a contact surface; and
the means for imparting rotation comprise a motor situated on an outer surface of the peripheral wall and a connection member for connecting the motor and the contact surface;
such that when the motor is actuated it causes the connection member to impart rotational movement to the contact surface of the at least one roller.

6. The device of claim 5 wherein the contact surface is a toothed surface and the connection member is a chain drive belt.

7. The device of claim 6 comprising a plurality of rollers, each with a driven end and toothed surface, and the chain drive belt mating with each toothed surface in series.

8. The device of claim 5 wherein the motor is a hydraulic motor powered by hydraulic lines.

9. The device of claim 1 further comprising an upper wall for channeling the field additives toward the at least one protuberance.

10. The device of claim 1 further comprising safety grill overlying the at least one roller.

11. The device of claim 1 further comprising mounting means for mounting peripheral wall on a receiving implement.

12. The device of claim 11 wherein the receiving implement is selected from the group consisting of a grain auger, a belt conveyor and a transfer auger.

13. The device of claim 1 wherein the open space extends through the device to allow the field additives to pass through the device.

14. The device of claim 3 wherein the protuberances of the adjacent rollers are positioned and configured such that disaggregated field additives can progress downwardly past the adjacent rollers during rotation of the adjacent rollers.
